(19) United States
(12) Patent Application Publication
(10) Pub. No.: US 2008/0120874 A1
(43) Pub. Date: May 29, 2008

(54) Holder to facilitate the signing and storage of collectable trading cards and other card-like memorabilia

(76) Inventor: James Schroeder, (US)

Correspondence Address: Patrick P. Zaretski, Esq.;Law Offices, 51 Young Avenue, Totowa, NJ, 07512-2044, US

(21) Appl. No.: 11/455,965

(22) Filed: Jun. 19, 2006

(51) Int. Cl. G09F 1/10

(52) U.S. Cl. 40/124.4; 40/772

(57) ABSTRACT

An apparatus, and method of use thereof, to assist in the signing and display of trading cards. The main body of the apparatus, preferably constructed from plastic, is shaped and angled to facilitate signing an inserted card while the apparatus rests on a flat surface. Means for attaching or holding a writing implement is provided on the apparatus. Means is further provided in the apparatus to cover the signed card to prevent damage to the card. In alternative embodiments, the apparatus may be constructed in a multiple-piece, interlocking design to permit several uses if desired. The apparatus may also bear graphical information for advertising, identification, or other informational uses.

### TECHNICAL FIELD OF THE INVENTION

This invention relates to collectable memorabilia holders, and more particularly to an apparatus, and method of use thereof, for holding a trading card or other similar memorabilia article in such a way as to facilitate its signing for autographs and/or later storage.

### BACKGROUND ART

The trading card industry, wherein photographs or other images of professional athletes or celebrities, or various other images stemming from popular culture, are printed onto standard-sized cardboard cards for collecting or trading, is a multimillion dollar industry with net revenues of nearly $580 million in 2005. Having the depicted athlete or celebrity personally sign his or her autograph on the card is highly desirable among collectors, either to enhance the collectable value of the card or to provide sentimental or remembrance value for an interested collector. While it is of course possible to have professional athletes or celebrities autograph these cards under more optimal conditions such as at sports memorabilia stores, conventions, or other locations, a significant number of autograph signings occur more spontaneously such as at a baseball field prior to a game's start or at a location prior to a movie premiere or awards show, when players and celebrities are more apt to interact with the fans. Nevertheless, this informal and impromptu signing procedure presents a number of problems to both the signing personality and the fan or collector.

First, much of the collectable value of a particular trading card depends upon its physical condition. Namely, cards that are free from scratches, bending, or other physical deterioration or flaws are worth more upon the collectable market than a card which bears such deterioration or flaws. As a baseball player on the field of play, for example, usually does not return to the field from practice but is likely to sign cards before leaving, he will likely still have on equipment like batting gloves which become dirty through game play and make it more likely that he will scuff the card. Additionally, the sweat from a player's hands after a vigorous practice can itself damage the card by dirtying its surface. Such scuffing and dirtying of the baseball card is of course highly deleterious to its aesthetic and monetary or collectable value. Of course, such potentially-damaging dirt, debris, or sweat may be on a signing celebrity's hands as well. It would therefore be desirable for a fan or collector wishing to have a signed card clean from dirt and other field debris to provide the signing personality with a card which is at least partly clean of such dirt or debris.

Next, bearing in mind the aforementioned collector's concern with quality of a signed trading card, it is desirable for the collector to have a means of protecting both the card itself and the signature upon the card which can be used as quickly and easily as possible after the signing. This will aid in keeping the generally small and easily-misplaced card from accidental loss, accidental smearing of the ink of the signature on the card, and so on.

Additionally, there are fans and collectors who do not keep their signed cards out of view or locked away after signing but who wish instead to display their cards, such as on a desk or shelf, much as they would a framed photograph. It is convenient and desirable for these fans or collectors who opt to display their cards in this manner to provide for a means of display which simultaneously protects the card from damage during signing from the outset and is both attractive and useful as a display means.

Finally, many times a professional athlete or celebrity who would be otherwise willing to sign a trading card is stymied in his attempt to do so because he does not have a pen and/or because he lacks a flat surface upon which to sign the card. Given the usually short amount of time a collector has to interact with that athlete or celebrity, waiting for a fan to produce a pen or flat support for the card is not something a signing personality wishes to do. Also, many times a casual fan does not possess a pen or flat surface such as a book but would still like to have a genuine autographed trading card. It would therefore be desirable for both a fan or collector and a signing athlete or celebrity to provide that signing personality with simultaneously both a trading card to be signed and a pen and flat surface for the personality to use in one convenient package.

A survey of the recent prior art reveals many devices useful for storing and displaying trading cards, which are advantageous to the fan or collector by preventing a viewer from directly handling the card and thereby damaging it, ultimately protecting the piece from environmental degradation. Thus, for example, U.S. Pat. No. 6,722,070 to Ribaudo describes and claims a sports memorabilia and card display system having a substantially flat front portion for holding and displaying memorabilia. The display system comprises a frame, a backing supported by the frame, a plurality of cardholders for holding photographic memorabilia and a recessed chamber for holding an object of memorabilia associated with the photographic memorabilia. The cardholders, retaining the trading cards and attachable to the backing, are arranged about the chamber in an aesthetic manner. Similarly, U.S. Pat. No. 6,655,056 to Wolf, et al. describes and claims a trading card display and storage device wherein sports trading cards are attractively and functionally displayed and stored in an environment or setting related to the sport in which celebrity was achieved, comprising a replica of a sports stadium having a playing field for the play of a given sport and one or more sections to decks of spectator stands surrounding the field, the replication of the stands having slanted surfaces facing a simulation of the playing field for display of cards having relationship to the given sport. Thirdly, U.S. Pat. No. 6,640,474 to Knoerzer, et al. describes and claims a trading card having an electroluminescent feature in combination with a display stand providing a power source, such that when the trading card is placed in the display stand, the power source from the display stand energizes the electroluminescent feature of the trading card, thereby providing illuminated graphics and making the trading card more interactive. The trading card can further include a circuit that facilitates moving graphics displays and can also drive a speaker to allow for audio in conjunction with the illumination. Finally, U.S. Pat. No. 6,017,012 to Henson, Jr. describes and claims a card holder for displaying a collectable trading card which includes a pair of elongate leg members where the upper ends of the leg members pivotally coupled together. A scissors brace is extended between the leg members, each of which has an outwardly extending arm member whose distal ends each have an ledge extent outwardly extending from the respective arm member each bearing an upwardly extending stop knob spaced apart from the associated arm member. The lower ends of the leg members each have a resting foot as well.

However, it must be stressed none of the aforementioned prior art embodiments provides for an apparatus, and method of use thereof, which protects, stores, and displays a trading card yet also simultaneously provides a pen and flat surface for a signing personality to use in one convenient package, thereby facilitating the initial signing of the card in any situation.

### OBJECTS OF THE INVENTION AND INDUSTRIAL APPLICABILITY

Accordingly, it is a general object of the present invention to provide an apparatus, and method of use thereof, to aid simultaneously in the signing, protection, storage, and display of collectable trading cards or other card-like memorabilia while on the field of play and/or at impromptu times and situations.

It is an object of the present invention to provide an apparatus, and method of use thereof, to aid simultaneously in the signing, protection, storage, and display of collectable trading cards or other card-like memorabilia whereby the card is protected from being dirtied by the signing personality's hands, equipment, or other debris or material while on the field of play and/or at impromptu times and situations.

It is a further object of the present invention to provide an apparatus, and method of use thereof, to aid simultaneously in the signing, protection, storage, and display of collectable trading cards or other card-like memorabilia whereby the device provides the signing personality with some form of leverage to assist the signer in physically signing the card while standing on the field of play and/or at impromptu times and situations.

It is a still further object of the present invention to provide an apparatus, and method of use thereof, to aid simultaneously in the signing, protection, storage, and display of collectable trading cards or other card-like memorabilia whereby the device provides the signing personality standing on the field of play and/or at impromptu times and situations with both a card to be signed and a pen for the singer to use in one convenient package.

### SUMMARY OF THE INVENTION

Consequently, to achieve these and other aims and objectives, the present invention provides for an apparatus, and method of use thereof, to assist simultaneously in the signing on the field of play and/or at impromptu times and situations; protection; storage; and display of individual collectable trading cards or other card-like memorabilia. The apparatus is to be constructed of plastic, although other durable material may be used. In one particular embodiment, the apparatus consists of a main body centrally bearing four raised holders in a shape whose perimeter corresponds to the shape of a standard trading card. To add weight to the apparatus, the main body may be completely solid throughout its structure, although the main body may be hollow without impairing its function. The main body may be rectangular, although any appropriate geometric shape may be used; similarly, the apparatus may assume any appropriate color or surface texture. On the front surface of the main body, a plurality of horizontal and vertical holes is disposed around the card-shaped perimeter formed by the four raised holders. The main body continuously flares outward proximally, distally, and laterally on the front and rear surfaces at its bottom edge to form a flattened lower end which allows the main body to stand vertically upward on any flat surface without additional support. To facilitate signing in this position, the main body may stand on a flat surface at an angle of up to thirty degrees (30°) relative to the flattened lower end. A hollowed projection is centrally found upon the top edge of the main body of the apparatus and continuously integrated therefrom, into which a writing instrument is to be reversibly inserted into a hole in this projection to provide a signing personality which such an instrument upon signing. In this embodiment, the lower corners of a trading card are first inserted into the lower two of the four raised holders and lightly bent into an arc, so that the upper corners of the card may then be inserted into the remaining upper two raised holders and the card thus reversibly placed into the apparatus. This reversible placement of the card allows the fan or collector the option to use the apparatus with a different card if desired. A separate cover slightly larger than a standard trading card, manufactured from transparent or translucent material and bearing a plurality of horizontal and vertical flanges rising directly outwardly from its rear surface, corresponding to the horizontal and vertical holes outside the card-shaped perimeter on the main body, is placed over the signed card and locked into place by inserting the flanges into the corresponding holes, thereby protecting the signed card from damage while still permitting viewing of the card. Sufficient surface area around the card and cover is left to place or imprint additional alphanumeric or graphic information, such as the signing personality's name, team or movie logo, etc.

In a related embodiment similar in all other respects to that previously described, the main body of the apparatus is still inclined at an angle of up to 30° from a flat surface upon which it rests, but the bottom edge of the main body does not continuously flare outward proximally, distally, and laterally edge to form a flattened lower end. Rather, support is provided through a reversibly-rotatable triangular projection directly integrated upon or otherwise affixed to the rear surface of the main body. The perimeter of the rotatable projection has a grippable edge facing outward from the rear surface of the main body evident when the rotatable projection is stored in its unrotated position; this grippable edge eases gripping and moving the stored projection. Upon its reversible rotation perpendicular to the main body, the vertex of the triangle formed by the rotatable projection and the right and left points of the bottom edge of the main body together form a base which bears the weight of the main body. The rotation of the projection is reversible to facilitate storage of the apparatus in a flat manner, such as in a drawer or stacking like books.

In an alternative embodiment, the apparatus is constructed from multiple pieces fitting together around a trading card to form a main body. Again, the apparatus is to be constructed of plastic, although other durable material may be used; to add weight to the apparatus, each piece forming the main body may be completely solid throughout its structure, although each piece may be hollow without impairing the apparatus' function. Also again, the assembled main body may be rectangular, although any appropriate geometric shape may be used; similarly, the apparatus may assume any appropriate color or surface texture. This embodiment of the apparatus consists of a front piece of the main body into which a standard trading card-sized hole is centrally placed to make possible the signing and display of the inserted card. On the rear surface of the front piece, four columns rise outwardly from the corners of the card-shaped hole. One-half of a hollowed projection is centrally found upon the top edge of the front piece of the main body of the apparatus, continuously integrated from the front piece and bearing a hole into which a writing instrument is to be reversibly inserted to provide a signing personality which such an instrument upon signing. Additionally, a thin flange projects outwardly from each lateral end of the rear surface of the front piece. On the front surface of the front piece, a plurality of horizontally-oriented holes and vertically-oriented holes is placed close to the perimeter of the card-shaped hole. The rear piece of the main body comprises on its top edge a hollowed projection to hold a writing instrument corresponding to that found on the front piece. Also, the lateral ends of the front surface of the rear piece bear grooves corresponding to the flanges of the front piece into which these flanges are to be inserted, thereby permitting assembly of the main body of the apparatus. Corresponding to the card-shaped hole of the front piece, indented guiding lines and/or four columnar holders congruous to those on the rear surface on the front piece are imprinted or otherwise embossed onto the front surface of the rear piece to aid the fan or collector in the alignment and placement of a card in the interior of the main body. Upon assembly of the main body, the four columns on the rear surface of the front piece fit onto the four corresponding corners of the card, thereby holding the card in place in the main body and preventing it from slipping during the main body assemblage or upon signing. As with the previous embodiment, a separate cover slightly larger than a standard trading card, manufactured from transparent or translucent material and bearing a plurality of flanges rising directly outwardly from its rear surface, corresponding to the holes outside the perimeter of the card-shaped hole on the front piece, is placed over the card-shaped hole after the card is signed and locked into place by inserting the flanges into the corresponding holes, thereby protecting the signed card from damage while still permitting viewing of the card. Again, each piece forming the main body of the apparatus may continuously flares outwardly proximally or distally and laterally at its bottom edge to form a flattened lower end which allows the assembled main body to stand vertically upward on any flat surface without additional support. To facilitate signing in this position, furthermore, the assembled main body may again stand at an angle of up to 30° relative to the flattened lower end. Finally, sufficient surface area around the card and cover is again left to place or imprint additional alphanumeric or graphic information, such as the signing personality's name, team or movie logo, etc. The multi-piece nature of this embodiment of the apparatus makes removal of the card and subsequent reuse of the apparatus more convenient for the fan or collector. An additional transparent or translucent sheet may be disposed between the front surface of the trading card and the rear surface of the front piece to provide enhanced protection of the card.

### BRIEF DESCRIPTION OF THE DRAWINGS

FIGS. 1, 2, 3, and 4 show a front, lateral, rear, and oblique view, respectively, of one embodiment of the apparatus with a trading card inserted therein.

FIGS. 5, 6a, and 6b show a lateral and rear view, respectively, of an alternative embodiment of the apparatus showing both affixed and rotated positions of a rear-positioned a rotatable triangular projection on the main body of the apparatus.

FIGS. 7, 8, and 9 show an exploded oblique, lateral, and assembled oblique view, respectively, of a second, multipiece alternative embodiment of the apparatus with a trading card inserted therein.

### DETAILED DESCRIPTION OF THE INVENTION

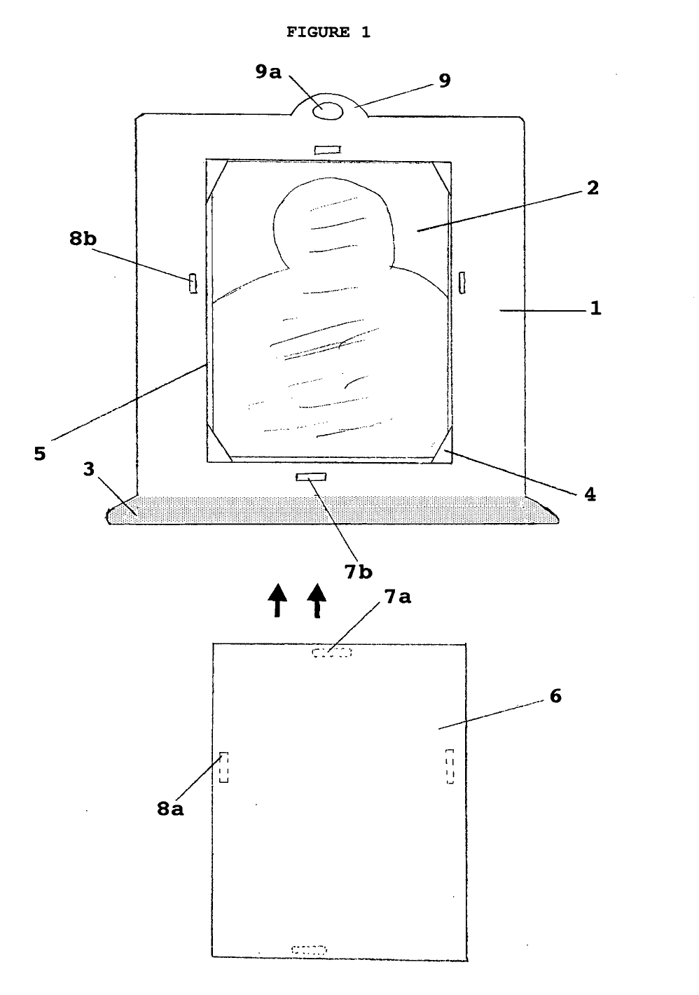

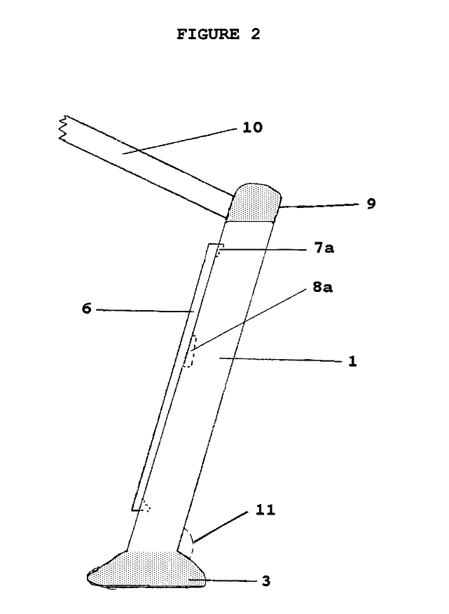

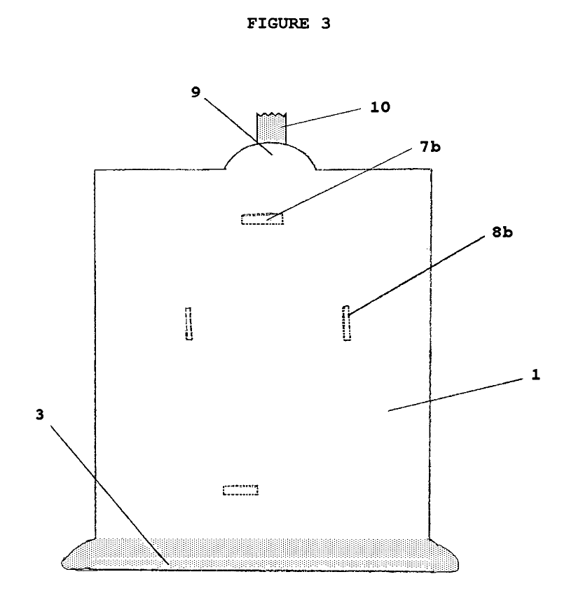

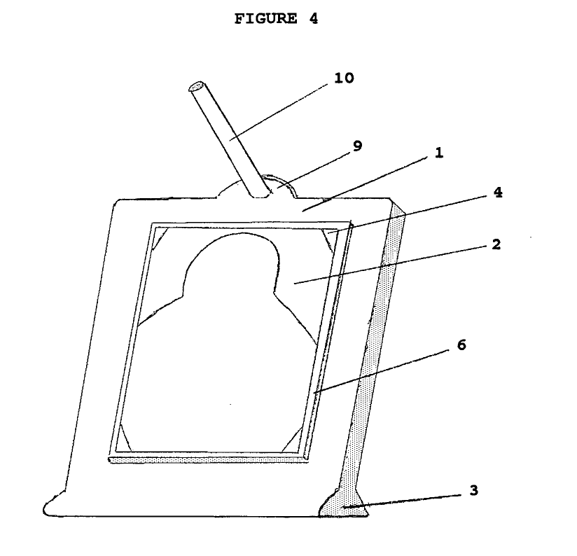

There is depicted in FIG. 1 an apparatus to be used simultaneously to assist in the signing on the field of play and/or at impromptu times and situations; protection; storage; and display of an individual collectable trading card 2 or other card-like memorabilia. The apparatus is to be constructed of plastic, although other durable material may be used. As seen in FIG. 1, the apparatus consists of a main body 1 centrally bearing four raised holders 4 positioned in a shape whose perimeter corresponds to that of a standard trading card 2, or approximately two-and-one-half inches by three and one-half inches (2.5″×3.5″). To add weight to the apparatus, the main body 1 may be completely solid throughout its structure, although the main body 1 may also be hollow without impairing its function. The apparatus may be rectangular, although any appropriate geometric shape may be used; similarly, the apparatus may assume any appropriate color or surface texture. On the front surface of the main body 1, a plurality of horizontal holes 7b and vertical holes 8b is disposed around the card-shaped perimeter formed by the four raised holders 4; in FIG. 1, two of each is illustrated. The main body 1 continuously flares outward proximally, distally, and laterally on the front and rear surface at its bottom edge to form a flattened lower end 3 which allows the main body 1 to stand vertically upward on any flat surface without additional support. To facilitate signing in this position, as seen in FIG. 2, the main body 1 may stand on a flat surface at an angle of up to 30° seen at 11 relative to the flattened lower end 3. A hollowed projection 9 is centrally found upon the top edge of the main body 1 and continuously integrated therefrom, into which, as seen in FIGS. 2, 3, and 4, a writing instrument 10 is to be reversibly inserted into a hole 9a in this projection 9 to provide a signing personality which such an instrument upon signing. In this embodiment, the lower corners of a trading card 2 are first inserted into the lower two of the four raised holders 4 and lightly bent into an arc, so that the upper corners of the card 2 may then be inserted into the remaining upper two raised holders 4 and the card 2 thus reversibly placed into the apparatus. This reversible placement of the card 2 allows the fan or collector the option to use the apparatus with a different card 2 if desired. As illustrated in FIGS. 1 and 2, a separate cover 6 slightly larger than a standard trading card 2, manufactured from transparent or translucent material and bearing a plurality of horizontal flanges 7a and vertical flanges 8a rising directly outwardly from its rear surface, corresponding to the horizontal holes 7b and vertical holes 8b outside the card-shaped perimeter on the main body 1, is placed over the signed card 2 and locked into place by inserting the flanges 7a and 8a into their corresponding holes 7b and 8b, thereby protecting the signed card 2 from damage while still permitting viewing of the card 2. As is evident from FIGS. 1 and 4, sufficient surface area around the card 2 and cover 6 is left on the main body 1 to place or imprint additional alphanumeric or graphic information, such as the signing personality's name, team or movie logo, etc.

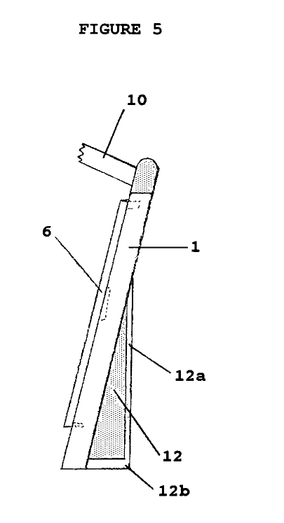

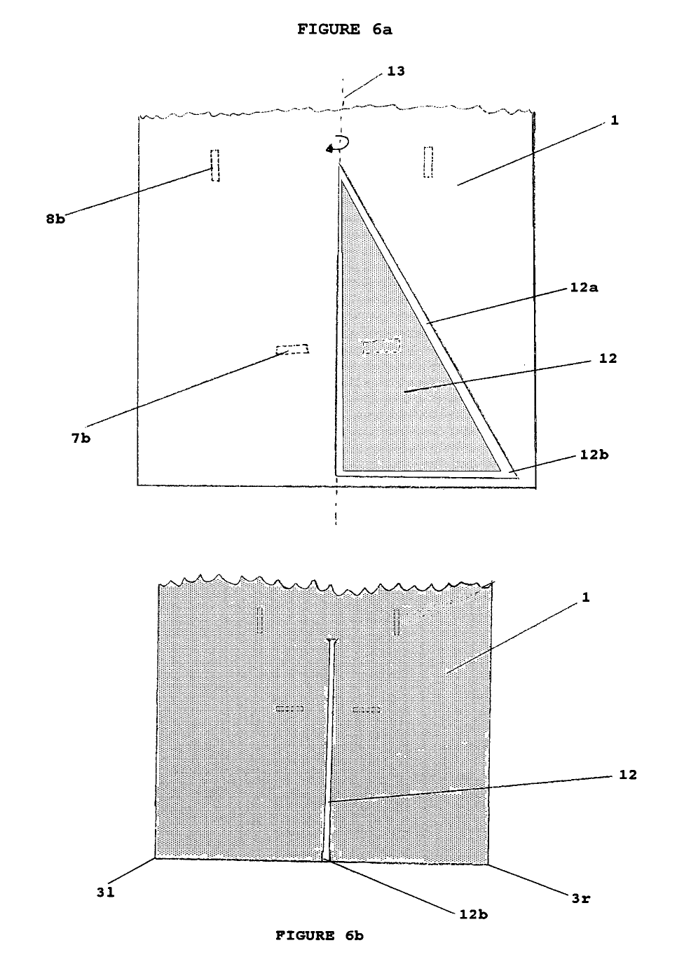

Turning to FIG. 5, in an embodiment similar in all other respects to that shown in FIGS. 1 through 4, the main body 1 of the apparatus is still inclined at an angle of up to 30° from a flat surface upon which it rests, but the bottom edge of the main body 1 does not continuously flare outward proximally, distally, and laterally edge to form a flattened lower end. Rather, support is provided through a reversibly-rotatable triangular projection 12 directly integrated upon or otherwise affixed to the rear surface of the main body 1, as is illustrated in FIGS. 6a and 6b. The perimeter of the rotatable projection 12 has a grippable edge 12a facing outward from the rear surface of the main body 1 evident when the rotatable projection 12 is stored in its unrotated position; this grippable edge 12a eases gripping and moving the stored projection 12. Upon its reversible rotation perpendicular to the main body along the axis positioned at 13, the vertex 12b of the triangle formed by the rotatable projection 12 and the right and left points 3r and 31 of the bottom edge of the main body 1 together form a base which bears the weight of the main body 1. The rotation of the projection 12 is reversible to facilitate storage of the apparatus in a flat manner, such as in a drawer or stacking like books.

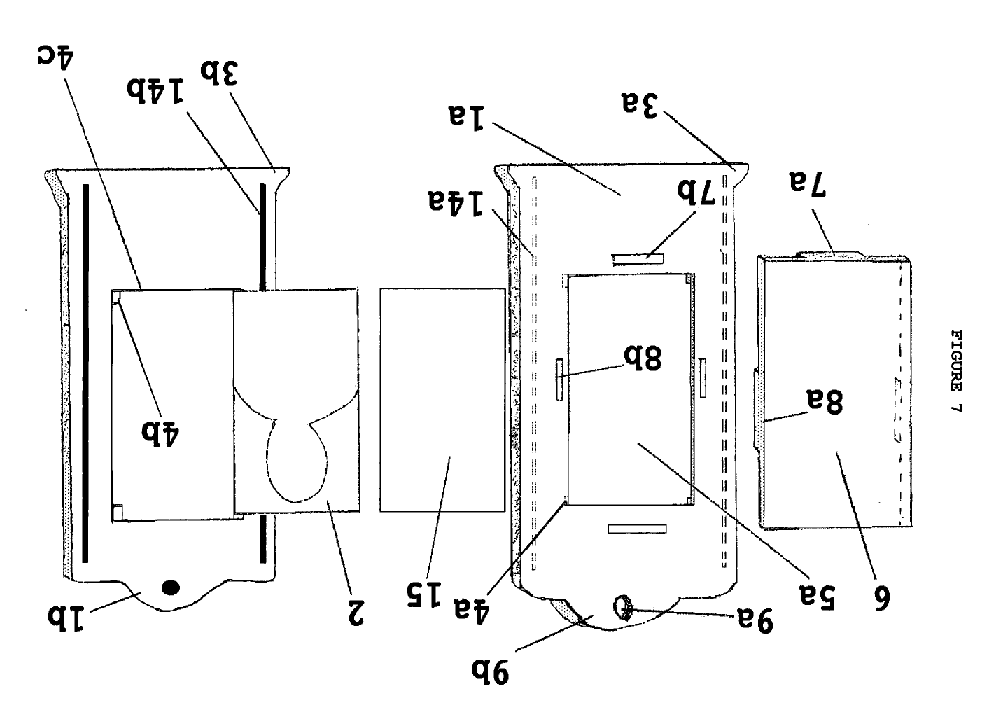

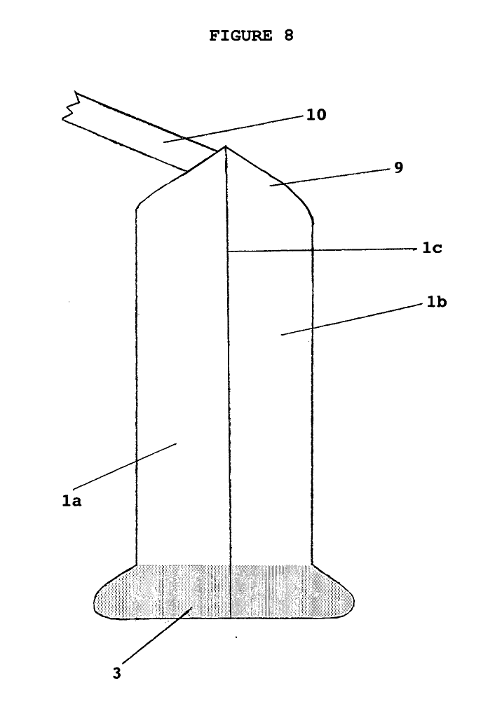

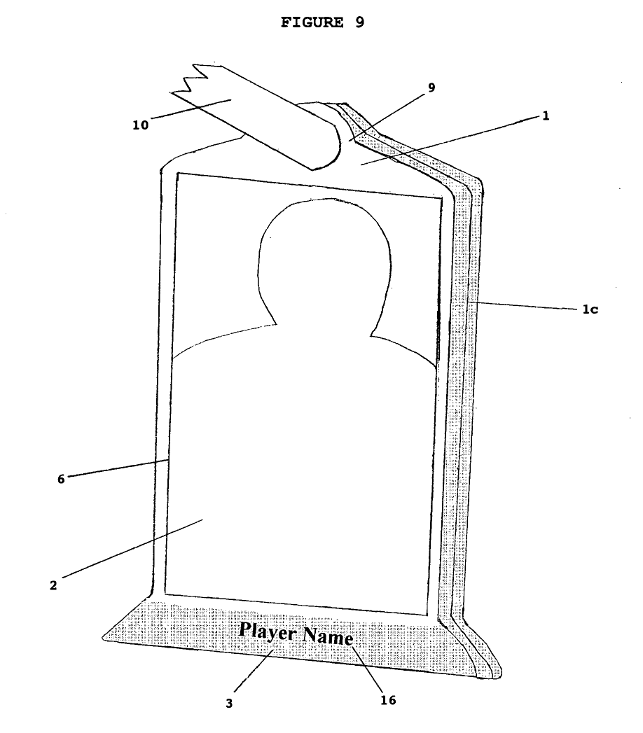

An alternative embodiment of the apparatus is depicted in FIGS. 7, 8, and 9. In this embodiment, the apparatus is constructed from multiple pieces 1a and 1b fitting together at 1c around a trading card 2 to form a main body 1. Again, the apparatus is to be constructed of plastic, although other durable material may be used; to add weight to the apparatus, each piece 1a and 1b forming the main body 1 may be completely solid throughout its structure, although each piece may be hollow without impairing the apparatus' function. Also again, the assembled main body 1 may be rectangular, although any appropriate geometric shape may be used; similarly, the apparatus may assume any appropriate color or surface texture. This embodiment of the apparatus consists of a front piece 1a of the main body 1 into which a standard trading card-sized hole 5a is centrally placed to make possible the signing and display of the inserted card 2. On the rear surface of the front piece 1a, four columns 4a rise outwardly from the corners of the card-shaped hole 5a. One-half of a hollowed projection 9b is centrally found upon the top edge of the front piece 1a of the main body 1, continuously integrated from the front piece 1a and bearing a hole 9a into which a writing instrument 10 is to be reversibly inserted to provide a signing personality which such an instrument 10 upon signing. Additionally, a thin flange 14a projects outwardly from each lateral end of the rear surface of the front piece 1a. On the front surface of the front piece, a plurality of horizontally-oriented holes 7b and vertically-oriented holes 8b is placed close to the perimeter of the card-shaped hole 5a. The rear piece 1b of the main body 1 comprises on its top edge a hollowed projection 9c to hold a writing instrument 10 corresponding to that found on the front piece 1a. Also, the lateral ends of the front surface of the rear piece bear grooves 14b corresponding to the flanges 14a of the front piece 1a into which these flanges 14a are to be inserted, thereby permitting assembly of the main body 1 of the apparatus. Corresponding to the card-shaped hole 5a of the front piece 1a, indented guiding lines 4b and/or four columnar holders 4c congruous to those 4a on the rear surface on the front piece 1a, are imprinted or otherwise embossed onto the front surface of the rear piece 1b to aid the fan or collector in the alignment and placement of a card 2 in the interior of the main body 1. Upon assembly of the main body 1, the four columns 4a on the rear surface of the front piece 1a fit onto the four corresponding corners of the card 2, thereby holding the card 2 in place in the main body and preventing it from slipping during the main body 1 assemblage or upon signing. As with the previous embodiment, a separate cover 6 slightly larger than a standard trading card 2, manufactured from transparent or translucent material and bearing a plurality of flanges 7a and 8a rising directly outwardly from its rear surface, corresponding to the holes 7b and 8b outside the perimeter of the card-shaped hole 5a on the front piece 1a, is placed over the card-shaped hole 5a after the card 2 is signed and locked into place by inserting the flanges 7a and 8a into the corresponding holes 7b and 8b, thereby protecting the signed card 2 from damage while still permitting viewing of the card 2. Again, each piece 1a and 1b forming the main body 1 of the apparatus may continuously flare outwardly proximally or distally and laterally at its bottom edge as seen at 3a and 3b to form a flattened lower end 3 which allows the assembled main body 1 to stand vertically upward on any flat surface without additional support. To facilitate signing in this position, furthermore, the assembled main body 1 may again stand at an angle of up to 30° relative to the flattened lower end 3. Finally, as is evident in FIG. 9, sufficient surface area around the card 2 and cover 6 is again left to place or imprint additional alphanumeric or graphic information 16, such as the signing personality's name, team or movie logo, etc. The multi-piece nature of this embodiment of the apparatus makes removal of the card 2 and subsequent reuse of the apparatus more convenient for the fan or collector. An additional transparent or translucent sheet 15 may be disposed between the front surface of the trading card 2 and the rear surface of the front piece 1a to provide enhanced protection of the card 2.

The apparatus described herein was designed and manufactured to fit a trading card 6 of standard industry size. However, it is contemplated that other types of papers amenable to collectible signatures, such as postcards, differently-sized photographs, or other types of documents are also capable of being signed and fitted into the apparatus in this manner. Also, especially with the multiple piece design, a cover 6 to be fitted over the card 2 may be redundant should a protective transparent or translucent sheet 15 be used instead; a manufacturer therefore might choose to dispense with this further protective option. Thus, while the present invention has been described in connection with exemplary embodiments thereof, it will be understood that many modifications in both design and use will be apparent to those of ordinary skill in the art, and this application is intended to cover any adaptations or variations thereof. It is therefore manifestly intended that this invention be limited only by the claims and the equivalents thereof.

The invention to be claimed is:

1. An apparatus to assist in the signing, protection, storage, and display of individual collectable trading cards and other card-like memorabilia, comprising:
a main body of the apparatus, comprising:
a central portion having front, rear, and top surfaces,
said front surface bearing four raised holders,
said four raised holders placed upon said central portion in a shape whose perimeter corresponds to the shape of a trading card, thereby forming a space to accept the trading card,
said front and rear surfaces flaring outward proximally, distally, and laterally at their lower edge to form a flattened lower end of the apparatus,
said top surface bearing a hollowed projection centrally positioned thereupon,
said hollowed projection having a hole drilled into the projection into which a writing instrument is to be reversibly inserted;
and a writing instrument.

2. The apparatus of claim 1, wherein the trading card measures approximately two-and-one-half inches by three and one-half inches (2.5″×3.5″).

3. The apparatus of claim 1, wherein the apparatus is constructed from plastic.

4. The apparatus of claim 1, wherein the apparatus is solid throughout its structure.

5. The apparatus of claim 1, wherein the apparatus is rectangular in shape.

6. The apparatus of claim 1, wherein the main body is positioned at an angle of up to thirty degrees (30°) relative to the flattened lower end.

7. The apparatus of claim 1, further comprising:
a plurality of horizontal and vertical holes disposed around the card-shaped perimeter formed by the four raised holders;
and a separate cover manufactured from transparent or translucent material,
said cover being of a size slightly larger than a trading card,
said cover further bearing a plurality of horizontal and vertical flanges rising directly outwardly from its rear surface,
said cover flanges corresponding to said horizontal and vertical holes outside said card-shaped perimeter on the main body.

8. The apparatus of claim 7, wherein said cover flanges are reversibly inserted into said horizontal and vertical holes, thereby attaching said cover to the front surface of said main body.

9. The apparatus of claim 1, further comprising alphanumeric or graphic information disposed on the surface area of said main body.

10. The apparatus of claim 9, wherein the alphanumeric or graphic information is so provided from means selected from a group consisting of printing, etching, or embossing from the molded plastic of the apparatus.

11. A method of aiding in the signing, protection, storage, and display of individual collectable trading cards and other card-like memorabilia, comprising:
reversibly inserting the lower corners of a trading card into the lower two of the four raised holders on the main body of the apparatus of claim 1;
lightly bending the trading card into an arc;
and reversibly inserting the upper corners of the card into the remaining upper two raised holders.

12. The method of claim 11, further comprising reversibly attaching said cover onto said apparatus.

13. An apparatus to assist in the signing, protection, storage, and display of individual collectable trading cards and other card-like memorabilia, comprising:
a main body of the apparatus, comprising:
a central portion having front, rear, and top surfaces,
said front surface bearing four raised holders,
said four raised holders placed upon said central portion in a shape whose perimeter corresponds to the shape of a trading card, thereby forming a space to accept the trading card,
said rear surface bearing a reversibly-rotatable projection,
said projection bearing a grippable edge on the surface of said projection facing outward from said rear surface of the central portion,
said front and rear surfaces forming a lower end of the apparatus which is at an angle relative to said top surface when the apparatus is placed on a flat horizontal plane,
said top surface bearing a hollowed projection centrally positioned thereupon,
said hollowed projection having a hole drilled into the projection into which a writing instrument is to be reversibly inserted;
and a writing instrument.

14. The apparatus of claim 13, wherein the trading card measures approximately 2.5″×3.5″.

15. The apparatus of claim 13, wherein the apparatus is constructed from plastic.

16. The apparatus of claim 13, wherein the apparatus is solid throughout its structure.

17. The apparatus of claim 13, wherein the apparatus is rectangular in shape.

18. The apparatus of claim 13, wherein the angle between the lower end and the top surface of said central portion is an angle of up to 30°.

19. The apparatus of claim 13, further comprising:
a plurality of horizontal and vertical holes disposed around the card-shaped perimeter formed by the four raised holders;
and a separate cover manufactured from transparent or translucent material,
said cover being of a size slightly larger than a trading card,
said cover further bearing a plurality of horizontal and vertical flanges rising directly outwardly from its rear surface,
said cover flanges corresponding to said horizontal and vertical holes outside said card-shaped perimeter on the main body.

20. The apparatus of claim 19, wherein said cover flanges are reversibly inserted into said horizontal and vertical holes, thereby attaching said cover to the front surface of said main body.

21. The apparatus of claim 13, wherein said projection is triangular in shape.

22. The apparatus of claim 13, wherein said projection is directly integrated onto said rear surface.

23. The apparatus of claim 13, wherein said projection is affixed onto said rear surface.

24. The apparatus of claim 13, further comprising alphanumeric or graphic information disposed on the surface area of said main body.

25. The apparatus of claim 24, wherein the alphanumeric or graphic information is so provided from means selected from a group consisting of printing, etching, or embossing from the molded plastic of the apparatus.

26. A method of aiding in the signing, protection, storage, and display of individual collectable trading cards and other card-like memorabilia, comprising:
reversibly inserting the lower corners of a trading card into the lower two of the four raised holders on the main body of the apparatus of claim 13;
lightly bending the trading card into an arc;
reversibly inserting the upper corners of the card into the remaining upper two raised holders;
and reversibly rotating said projection perpendicular to the main body such that the vertex of said projection and the right and left points of the lower ends of said main body form a triangular base which bears the weight of said main body.

27. The method of claim 26, further comprising reversibly attaching said cover onto said apparatus.

28. An apparatus to assist in the signing, protection, storage, and display of individual collectable trading cards and other card-like memorabilia, comprising:
a main body of the apparatus, comprising:
a front piece having front, rear, top, and bottom surfaces,
said front piece having a hole whose perimeter corresponds to the shape of a trading card centrally placed therein,
said rear surface of said front piece having four columns rising outwardly from the corners of said card-shaped hole,
said rear surface of said front piece further having a thin flange projecting outwardly from each lateral end,
said top surface of said front piece bearing one-half of a hollowed projection centrally positioned thereupon to accept a writing implement,
said hollowed projection having a hole drilled into the projection into which a writing instrument is to be reversibly inserted,
said bottom surface of said front piece flaring outward proximally, distally, and laterally to form a flattened lower end;
a rear piece having front, rear, top, and bottom surfaces,
said front surface of said rear piece bearing on each lateral end a groove corresponding to said flanges of said front piece,
said front surface of said rear piece also bearing a means to place and align a card in the interior of the main body imprinted or otherwise embossed thereupon,
said top surface of said rear piece bearing one-half of a hollowed projection centrally positioned thereupon to accept a writing instrument complementary to said one-half on said front piece,
said bottom surface of said front piece flaring outward proximally, distally, and laterally to form a flattened lower end;
and a writing instrument.

29. The apparatus of claim 28, further comprising:
a plurality of horizontal and vertical holes disposed around said card-shaped hole of said front piece;
and a separate cover manufactured from transparent or translucent material,
said cover being of a size slightly larger than a trading card,
said cover further bearing a plurality of horizontal and vertical flanges rising directly outwardly from its rear surface,
said cover flanges corresponding to said horizontal and vertical holes outside said card-shaped hole on said front piece.

30. The apparatus of claim 29, wherein said cover flanges are reversibly inserted into said horizontal and vertical holes, thereby attaching said cover to the front surface of said front piece.

31. The apparatus of claim 28, further comprising a transparent or translucent sheet to be disposed between the front surface of the trading card and said rear surface of said front piece.

32. The apparatus of claim 28, wherein said placement and alignment means is indented guiding lines.

33. The apparatus of claim 28, wherein said placement and alignment means is four columnar holders congruous to those on the rear surface on said front piece.

34. The apparatus of claim 28, wherein the trading card measures approximately 2.5″×3.5″.

35. The apparatus of claim 28, wherein the apparatus is constructed from plastic.

36. The apparatus of claim 28, wherein the apparatus is solid throughout its structure.

37. The apparatus of claim 28, wherein the apparatus is rectangular in shape.

38. The apparatus of claim 28, wherein the main body is positioned at an angle of up to 30° relative to the flattened lower end.

39. The apparatus of claim 28, further comprising alphanumeric or graphic information disposed on the surface area of said main body.

40. The apparatus of claim 39, wherein the alphanumeric or graphic information is so provided from means selected from a group consisting of printing, etching, or embossing onto the apparatus.

41. A method of aiding in the signing, protection, storage, and display of individual collectable trading cards and other card-like memorabilia, comprising:
placing and aligning a trading card onto the rear surface of said rear piece of the main body of the apparatus of claim 28 using said guiding means;
fitting said columns on the rear surface of said front piece fit onto the four corresponding corners of the trading card; and
reversibly inserting said flanges on the rear surface of said front piece into said grooves on the front surface of said rear piece,
thereby locking said front and rear pieces of the main body together to form the main body.

42. The method of claim 41, further comprising reversibly attaching said cover onto said apparatus.

43. The method of claim 41, further comprising disposing said sheet between the trading card and said columns on the rear surface of said front piece.
